(19) United States
(12) Patent Application Publication
(10) Pub. No.: US 2025/0069770 A1
(43) Pub. Date: Feb. 27, 2025

(54) Ion trap

(71) Applicant: PHYSIKALISCH-TECHNISCHE BUNDESANSTALT BRAUNSCHWEIG UND BERLIN, Braunschweig (DE)

(72) Inventors: Tanja MEHLSTÄUBLER, Wendeburg (DE); Elena JORDAN, Braunschweig (DE)

(21) Appl. No.: 18/809,917

(22) Filed: Aug. 20, 2024

(30) Foreign Application Priority Data
Aug. 24, 2023 (DE) 10 2023 122 682.7

(51) Int. Cl. G21K 1/00

(52) U.S. Cl. CPC G21K 1/003

(57) ABSTRACT

An ion trap is generally constructed as a linear Paul trap in which at least one charged particle is radially trapped with the aid of a quadrupole radio frequency field. The ion trip has a first chip and a second chip aligned with respect to each other, and the two chips are preferably structurally identical. Both chips have a front side, a reverse side, and a chip slot. The second chip is attached to the first chip such that a vertical projection onto a first-chip plane, along which the first chip extends, results in an ion trap slot. The first and second chips each have DC voltage electrode, a compensation electrode, and a high-frequency electrode, and each electrode is designed to receive a DC voltage, and preferably all of the electrodes are electrically insulated from one another.

### FIELD OF THE INVENTION

The invention relates to an ion trap. Ion traps are already successfully used, for example, in quantum computers, quantum simulators, atomic clocks and quantum sensors. As is the case with the ion trap according to the invention, ion traps are generally constructed as Paul traps in which at least one charged particle is radially trapped with the aid of a quadrupole radio frequency field. In linear Paul traps, which the invention likewise relates to, additional electrodes are provided by means of which ions can be trapped along a longitudinal axis by applying DC voltages. Chip-based ion traps, which the invention relates to, can be manufactured both efficiently and with high precision.

### BACKGROUND

It is known to construct chip-based ion traps from four or two microchips.

DE 10 2019 205183 A1 describes a method for producing an ion trap in which two substrates are used to which at least one insulation area and, in each case, one metallisation are applied. Bonding surfaces are formed on the sides of the substrates facing each other, thereby bonding the substrates together. A continuous recess is formed in one substrate, the insulation being removed in the area of said recess. This allows the construction of three-dimensional ion traps with low HF absorption.

US 2010/0 084 549 A1 describes an electrostatic ion trap for ions with various mass/charge ratios and various kinetic energies in an anharmonic potential well. The ion trap excites the trapped ions by means of an AC current drive with a low amplitude. The mass-dependent oscillation amplitudes of the excited ions are enlarged with increasing energy due to an auto-resonance between the AC drive frequency and the natural oscillation frequencies of the ions until the oscillation amplitudes of the ions exceed the physical dimensions of the trap or the ions fragment or are subject to another physical or chemical transformation.

US 2017/0 221693 A1 describes an ion trap with two bar-shaped RF electrodes, two DC voltage electrodes and a laser passage to the ion trapping zone. The RF electrodes are arranged parallel in the longitudinal direction of the ion trap, one being arranged on the upper side of the first side and one on the lower side of the first side.

A DC voltage electrode is arranged on the upper side of the second side and the second HF electrode bar is arranged on the lower side of the second side. A laser passage extends from the outer side of the first or second side of the substrate to the ion trapping zone. This results in a laser path that penetrates an ion trapping structure so that fewer lasers are required to trap and cool the ions.

The paper “Industrially microfabricated ion trap with 1 eV trap depth.” by S. Auchter, Quantum Science and Technology 7 (2022) 035015, describes an ion trap that is produced on stacked eight-inch wafers. The electrodes are structured on the surfaces of two opposite wafers that are connected by a spacer. They form a 3D structure with a misalignment across the stack with a standard deviation of 2.5 pm.

The paper “Design, fabrication and characterization of a micro-fabricated stacked-wafer segmented ion trap with two X-junctions.” by C. Decaroli et al., Quantum Science and Technology 6 (2021) 044001, describes a three-dimensional Paul ion trap that is produced from a stack of precision-made silicon dioxide glass panels and contains a pair of connections for two-dimensional ion transport. The ion trap has a plurality of electrodes, by means of which multiple potential wells are built up.

The paper “A review of silicon microfabricated ion traps for quantum information processing.” by Dong-II Cho et al., Micro and Nano Systems Letters (2015) 3:2, p. 1-12, provides an overview of ion traps that can be manufactured by both conventional precision machining and MEMS-based microfabrication.

### SUMMARY

The invention aims to propose an improved ion trap.

The invention solves the problem by way of an ion trap with
(a) a first chip that has (i) a first-chip front side and a first-chip reverse side and (ii) comprises a first-chip slot, as well as
(b) a second chip that has (i) a second-chip front side and a second-chip reverse side, (ii) comprises a second-chip slot and (iii) is attached to the first chip such that a vertical projection onto a first-chip plane, along which the first chip extends, results in an ion trap slot, wherein
(c) the first chip has a first-chip segment in which the first chip
(i) has a first DC voltage electrode which is at least also arranged on the first-chip reverse side; extends at least in sections, in particular at least largely, along the first-chip plane; is configured to receive a first DC voltage U_{DC1,1}; is arranged on a first edge side in terms of the first-chip slot, and abuts the slot, and
(ii) has a first compensation electrode which is at least also arranged on the first-chip front side; extends at least in sections, in particular at least largely, along the first-chip plane; is configured to receive a second DC voltage U_{DC2,1}, and is arranged on the first edge side in terms of the first-chip slot. Preferably,
(d) the first chip has a first-chip high-frequency electrode that (i) is arranged on a second edge side of the first chip, which lies opposite the first edge side with respect to the first-chip slot, and is arranged opposite the first compensation electrode, and
(ii) is arranged opposite a second compensation electrode, which is arranged on the second chip, and/or opposite a second DC voltage electrode arranged on the second chip, and (iii) is configured to receive a high frequency voltage (RF). In this case, (e) the second chip preferably has (i) a second-chip segment that is located downstream of the DC voltage electrode in the direction of a normal to the first-chip plane, (ii) a second DC voltage electrode, which is at least also arranged on the second-chip front side, extends at least in sections, in particular at least largely, along the second-chip plane and is configured to receive a third DC voltage U_{DC3,1}, and (iii) a second compensation electrode, which is at least also arranged on the second-chip reverse side, extends at least in sections, in particular at least largely, along the second-chip plane and is configured to receive a fourth DC voltage U_{DC4,1}. The second chip comprises (f) a second-chip high-frequency electrode located downstream of the first-chip segment in the direction of a normal to the first-chip plane. Preferably, all compensation electrodes are electrically insulated against each other. Preferably, all DC voltage electrodes are electrically insulated against each other. In particular, the compensation electrodes and the DC voltage electrodes are electrically insulated against each other.

An advantage when compared with ion traps consisting of four chips is that production is easier. In particular, it is easier to align two chips to each other than four chips.

It is practical if the first chip and the second chip are structurally identical with regard to the objects. In other words, it is possible that both chips are constructed differently in different parts. However, it is especially practical if both chips are structurally identical.

It is also advantageous that the first compensation electrode and the second compensation electrode can be arranged in such a way that a lower voltage usually has to be applied compared to ion traps of the prior art in order to achieve the same electric field strength in the trap volume. In other words, feed-through is improved.

A further practical aspect is that the arrangement of the DC voltage electrodes and the compensation electrode on opposite sides of the same chip generally results in less interference of the high-frequency voltage applied to the high-frequency electrodes.

It is also practical that both chips can be assigned different potentials on their respective front and reverse sides.

In addition, the range of angles at which photons emitted by an ion in the trap volume can be detected can be selected to be comparatively large.

Within the scope of the present description, the terms ‘front side’ and ‘reverse side’ each relate to the same spatial direction. In other words, the first-chip front side points in the same direction as the second-chip front side. Correspondingly, the first-chip reverse side points in the same direction as the second-chip reverse side. In other words, the normal vectors extend to the corresponding sides in the same direction.

In particular, the high-frequency electrodes are arranged in such a way that a trap volume for storing an ion is formed by applying a suitable high-frequency voltage.

For example, the electrodes can be designed as metallizations on a substrate.

In particular, the substrate is an insulator or semi-conductor, such as aluminum nitride or sapphire. A substrate thickness of the substrate is preferably 150 μm to 1500 μm. A suitable substrate thickness is 400±50 μm. The substrate thickness is the distance of a compensation plane through the first-chip front side from a compensation plane through the first-chip reverse side.

The feature that the second chip is fixed to the first chip such that a slot of the ion trap is formed in vertical projection onto the first-chip plane E₁₂ is understood in particular to mean that the first-chip slot and the second-chip slot overlap each other when viewed in a direction perpendicular to the first-chip plane such that the slot is formed. The slot is a material-free area of the ion trap, whereas the first-chip slot is a material-free area of the first chip and the second-chip slot is a material-free area of the second chip.

It is possible and preferable, but not essential, for the first-chip slot and the second-chip slot to at least largely completely overlap. This is understood to mean that the vertical projection of the first-chip slot onto the first-chip plane at least largely corresponds to the vertical projection of the second-chip slot onto the first-chip plane.

The feature that the projections at least largely correspond to each other is understood particularly to mean that is possible and advantageous, but not essential, for the projections to be at least largely identical in the mathematical sense. In particular, it is possible that the two projections deviate from one another, for example by at most 20%, especially at most 15%, especially at most 10%, especially at most 5% of the slot area. The slot area is the area of the slot. The more effectively the projections correspond to each other, the better it generally is. Deviations from a uniformity in a mathematical sense are usually inevitable but tolerable, provided that they do not influence the functionality of the ion trap too much.

The edge sides refer to the opposite areas separated from each other by the slot. The word ‘side’ can be used instead of ‘edge side’.

The feature that the first DC voltage electrode is designed to receive a first DC voltage and the second DC voltage electrode is designed to receive a second DC voltage is understood particularly to mean that the DC voltage electrodes are arranged in such a way that ions can be trapped and held in the trap volume by applying suitable DC voltages when a suitable high-frequency voltage is acting on the high-frequency electrodes.

The feature that the compensation electrodes are designed to receive a second or fourth DC voltage is understood in particular to mean that the compensation electrodes are arranged in such a way that stray fields in the trap volume can be compensated by applying the second or fourth DC voltage, so that the ions can be displaced into a minimum of the high-frequency field.

A high-frequency voltage refers to a voltage with a frequency of at least 300 kHz, especially at least 500 KHz.

A DC voltage refers in particular to a voltage whose spectrum has a maximum that is not above 10 MHz. The voltage is referred to as a DC voltage because, unlike with the high-frequency electrode, a continuously high-frequency AC voltage does not have to be applied for the ion trap to work. However, in order to quickly move the ions, also known as ‘shuttling’, switching frequencies into the megahertz range can be applied.

According to a preferred embodiment, the first-chip segment has a recess on an edge surface that is adjacent to the first-chip slot and extends transversely to the first-chip plane. Preferably, an insulating strip extends between the first DC voltage electrode and the first compensation electrode in the area of the recess. This allows the insulation strip to be designed to be sufficiently wide so as to ensure safe electrical insulation. In addition, a comparatively small voltage on the first compensation electrode is enough to generate a sufficiently small electrical field in the trap volume to displace the at least one ion.

It is favorable if the first compensation electrode has a first-electrode recess section that extends along the first-chip plane and is spaced apart from the first-chip reverse side by less than the substrate thickness. The first-electrode recess section is in particular arranged on the first-chip front side. The area of the recess is not taken into account when determining the compensation plane through the first-chip front side and/or through the first-chip reverse side. In the first-electrode recess section, the distance of the first compensation electrode from the trap volume is smaller than it would be without a recess. This increases the so-called feed-through, i.e. the ratio of electrical field strength in the trap volume to the voltage applied to the DC voltage electrode.

It is also practical if the first compensation electrode extends transversely to the first-chip plane (and therefore along the normal direction to the first-chip plane) in one section. This section preferably connects the first-electrode recess section with a main section of the first compensation electrode.

It is favorable if a distance h₀ between the first-electrode recess section and the reverse side of the first chip corresponds at most to 0.75 times, in particular at most 0.5 times, the substrate thickness of the chip. The substrate thickness usually corresponds to the thickness of the chip minus the thickness of the electrodes. Given that the latter are often metallizations that can be designed to be very thin, the substrate thickness usually corresponds to the chip thickness to a good approximation.

It is favorable if the second compensation electrode has a second-electrode recess section that extends along the second-chip plane and is spaced apart from the second-chip front side by less than the substrate thickness. The area of the recess is not taken into account when determining the compensation plane through the second-chip front side and/or through the second-chip reverse side. In the second-electrode recess section, the distance of the second compensation electrode from the trap volume is smaller than it would be without a recess.

It is also practical if the second compensation electrode extends transversely to the second-chip plane (and therefore along the normal direction to the second-chip plane) in one section. This section preferably connects the second-electrode recess section with a main section of the second electrode.

The first-chip segment is preferably tongue-shaped and extends in a segment extension direction that extends transversely to a slot extension direction of the first slot.

Alternatively or additionally, the second-chip segment is preferably tongue-shaped and extends in a segment extension direction that extends transversely to a slot extension direction of the second slot.

The recess is preferably designed in such a way that the second electrode is covered by the first electrode, as viewed from the trap volume.

The insulating strip between the first DC voltage electrode and the first compensation electrode is preferably covered by the first DC voltage electrode, as viewed from the trap volume. As a result, any electric charges present on the insulating strip are shielded from the first DC voltage electrode. It should be noted that the insulating strip is preferably not formed by applying a material to the substrate, although this is included in the invention. Specifically, the insulating strip is a strip that does not feature any metallizations and extends between the first DC voltage electrode and the first compensation electrode.

It is practical if the sine of half the opening angle of a cone whose tip lies in the centre of the trap volume and which does not intersect the ion trap is at least 0.45, in particular at least 0.5. In particular, the numerical aperture NA is at least 0.45. A numerical aperture of 0.71 is achievable.

Preferably, a clear chip distance d₁ of the two chips from each other deviates from a first slot width d₂ of the first-chip slot by at most 15%. Alternatively or additionally, the second slot width d₃ of the second-chip slot preferably deviates from the clear chip distance by at most 15%. The smaller the deviation, the more symmetrical the structure and the more efficiently ions can be trapped and held in the ion trap. Preferably, the second slot width d₃ corresponds to the first slot width d₂.

The first chip preferably comprises at least a second first-chip segment which is next to the first-chip segment in relation to a slot extension direction and is structured like the first-chip segment. Preferably, the first chip has at least three such segments. This allows an ion trap to be built for two or more ions.

The invention also includes an ion trap system with (a) at least one ion trap according to the invention and (b) a control unit which (i) is electrically connected to the electrodes and (ii) is configured to automatically apply a high-frequency voltage to the high-frequency electrode, thereby forming the trap volume, and a predetermined DC voltage to each DC voltage electrode and compensation electrode.

In addition, the control unit is preferably configured to apply a DC voltage that varies in terms of time, thus displacing ions stored in the trap volume.

Preferably, the ion trap system has a photodetector that is arranged to detect light emitted by at least one ion arranged in the trap volume.

### DESCRIPTION OF THE DRAWINGS

In the following, the invention will be explained with the aid of the accompanying drawings. They show

FIG. 1a a cross-section view through an ion trap according to the invention,

FIG. 1b a top view of the ion trap according to the invention according to FIG. 1a, and

FIG. 2 the second chip of the ion trap according to FIG. 1a.

### DETAILED DESCRIPTION

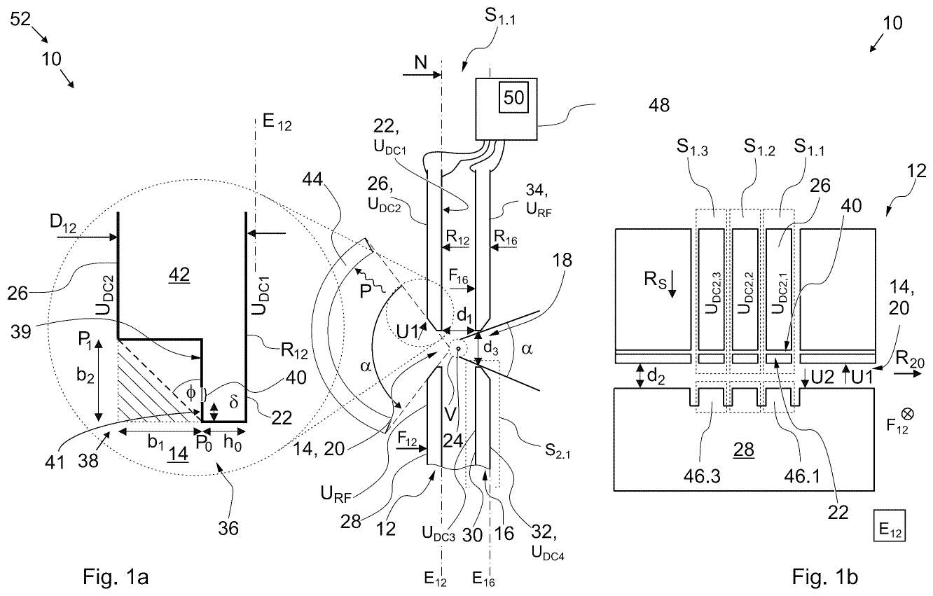

FIG. 1a shows an ion trap 10 comprising a first chip 12, which has a first-chip front side F₁₂ and a first-chip reverse side R₁₂ and features a first-chip slot 14. In addition, the ion trap 10 has a second chip 16, which has a second-chip front side F₁₆ and a second-chip reverse side R₁₆ and features a second-chip slot 18. The second chip 16 is fixed to the first chip 12 such that a slot 20 of the ion trap 10 is formed in vertical projection onto a first-chip plane E₁₂ along which the first chip 12 extends.

The first chip 12 has a first-chip segment S_{1.1}, in which the first chip 12 has a first DC voltage electrode 22 that is at least also arranged on the first-chip reverse side R₁₂ and extends in sections along the first-chip plane E₁₂. During operation, a first DC voltage U_{DC1,1} acts on the first DC voltage electrode 22, said voltage serving to trap an ion 24 in a trap volume V.

The first DC voltage electrode 22 is arranged on a first edge side U1 with respect to the first-chip slot 44 and abuts the slot 20. In the first-chip segment S1.1, the first chip 12 has a first compensation electrode 26, which is arranged on the first-chip front side F₁₂, extends along the first-chip plane E₁₂ and is arranged on the first edge side U1 with respect to the first-chip slot 14.

During operation of the ion trap 10, a second DC voltage U_{DC2,1} acts on the first compensation electrode 26, by means of which the ion 24 can be displaced along a slot extension direction along a combination of d2+d1.

The first chip 12 has a first-chip high-frequency electrode 28, which is arranged on the second edge side U2 opposite the first edge side U1 in relation to the slot 20. The first-chip high-frequency electrode 28 thus lies opposite the first DV voltage electrode 22 and the first compensation electrode 26. During operation, a high-frequency voltage U_{RF} acts on the first-chip high-frequency electrode 28.

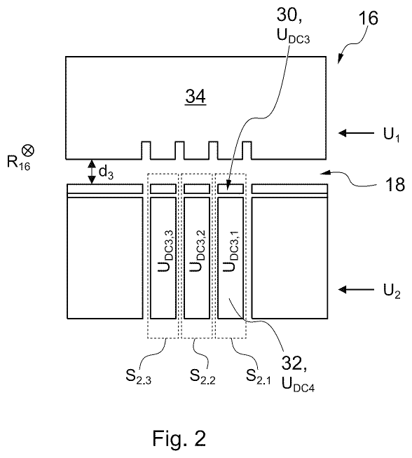

The second chip 16 has a second-chip segment S2.1 (see FIG. 2) that is located downstream of the first-chip high-frequency electrode 28 in the direction of a normal N to the first-chip plane E₁₂. The second chip 16 has a second DC voltage electrode 30, which is arranged on the second-chip front side F₁₆ and extends in sections along a second-chip plane E₁₆. During operation of the ion trap 10, a third DC voltage U_{DC3,1} acts on the second DC voltage electrode 30, by means of which the ion 24 is held in the trap volume V.

In addition, the second chip 16 has a second compensation electrode 32, which is arranged on the second-chip reverse side R₁₆ and extends largely along a second-chip plane E₁₆. During operation of the ion trap 10, a fourth DC voltage U_{DC4,1} acts on the second compensation electrode 32.

The second chip 16 also has a second-chip high-frequency electrode 34, which is located downstream of the first-chip segment S1.1 in the direction of the normal N. The compensation electrodes 26, 32 are electrically insulated against each other. Correspondingly, the DC current electrodes 22, 30 are electrically insulated against each other.

The enlargement in FIG. 1a shows that the first-chip segment S1.1 has a recess 38 on an edge surface 36 that is adjacent to the first-chip slot 14 and extends transversely to the first-chip plane E₁₂.

The first compensation electrode 26 has a first-electrode recess section 39 that extends along the first-chip plane E₁₂—preferably, but not necessarily, parallel to the first-chip plane E₁₂—and is spaced apart from the first-chip reverse side R₁₂. A distance h₀ between the first compensation electrode 26 in the first-electrode recess section 39 and the first DC voltage electrode 22 is thus smaller than a substrate thickness D₁₂=b₁+h₀ with a recess height b₁. The recess 39 has a recess depth b₂.

Between the first compensation electrode 26 and the first DC voltage electrode 22 is an insulating strip 40, in which a substrate 42 of the first chip 12 does not have a metallization. The insulating strip 40 can be at an insulating strip distance 8 from the edge surface 36. As in the present embodiment, the insulating strip 40 may extend between the first-electrode recess section 39 and a recess section 41 of the first DC voltage electrode 22. The recess section 41 extends along the first-chip plane E₁₂ and is spaced apart from the first-chip reverse side R₁₂ and is preferably at the same distance to the first-chip reverse side R₁₂ as the first-electrode recess section 39. However, the recess 38 may also have a form different to the one illustrated in FIG. 1a.

According to a preferred embodiment, the first DC voltage electrode 22 covers the insulating strip 40, as viewed from the trap volume V.

The second compensation electrode 32 may also feature a recess. It is preferably designed like the recess 39. The second chip 16 preferably, but not necessarily, has the structure shown in the enlargement, wherein the second compensation electrode 32 then corresponds to the first compensation electrode 26 and the second DC voltage electrode 30 corresponds to the first DC voltage electrode 22.

If the ion 24 in the trap volume V emits a photon 44, it can be absorbed by a photodetector 44 if it is emitted at an opening angle α. A second photodetector for light emitted in the opposite direction is not depicted.

FIG. 1b shows that the first chip 12 may comprise a first-chip segment S1.2 and, if necessary, at least a third first-chip segment S1.3. The first-chip segments S1.i (i=1, 2, . . . . N) are arranged next to one another along the slot extension direction R₂₀. It is favorable if the first-chip segments S1.i are constructed in the same way.

The first-chip high-frequency electrode 28 may comprise tongues 46.i, each of which is arranged opposite the first-chip segment S1.i and extends in a segment extension direction R_{S}.

FIG. 2 depicts the second chip 16, which is constructed in the same way as the first chip 12 and comprises second-chip segments S2.i. Each second-chip segment S2.i is arranged at the same height along the slot extension direction R₂₀ as the corresponding first-chip segment S1.i.

FIG. 1a schematically depicts a control unit 48 next to the photodetector, the former being connected to the electrodes and applying the respective voltage to them; it also constitutes part of an ion trap system 52. The voltages are controlled, for example, according to a predetermined program by means of a processor 50 of the control unit 48.

### REFERENCE SIGNS

10 ion trap
12 first chip
14 first-chip slot
16 second chip
18 second-chip slot
20 slot
22 first DC voltage electrode (U_{DC1,1})
24 ion
26 first compensation electrode (U_{DC2,1})
28 first-chip high-frequency electrode
30 second DC voltage electrode (U_{DC3,1})
32 second compensation electrode (U_{DC4,1})
34 second-chip high-frequency electrode
36 edge surface
38 recess
39 first-electrode recess section
40 insulating strip
41 recess section
42 substrate
44 photodetector
46 tongue
48 control unit
50 processor
52 ion trap system
α acceptance angle
δ insulating strip distance
b₁ recess height
b₂ recess depth
D₁₂ substrate thickness
E₁₂ first-chip plane
E₁₆ second-chip plane
12 first-chip front side
16 second-chip front side
h₀ distance
i numerical index
N normal
P photon
12 first-chip reverse side
16 second-chip reverse side
R₂₀ slot extension direction
R_{S} segment extension direction
S_{1.i} i-th first-chip segment
S_{2.1} second-chip segment
U_{DC1,1} first DC voltage
U_{DC2,1} second DC voltage
U_{DC3,1} third DC voltage
U_{DC4,1} fourth DC voltage
U₁ first edge side
U₂ second edge side
U_{RF} high-frequency voltage (radio frequency)
V trap volume

1. An ion trap, comprising:
a first chip comprising a first-chip front side and a first-chip reverse side, and a first-chip slot; and
a second chip comprising a second-chip front side and a second-chip reverse side, and a second-chip slot, wherein the second chips fixed to the first chip such that a slot of the ion trap is formed in vertical projection onto a first-chip plane along which the first chip extends,
wherein the first chip comprises a first-chip segment comprising
a first DC voltage electrode which
is arranged on the first-chip reverse side,
extends at least in sections along the first-chip plane,
is designed to apply a first DC voltage,
is arranged on a first edge side with respect to the first-chip slot, and
abuts the slot of the ion trap, and
a first compensation electrode which
is arranged on the first-chip front side,
extends at least in sections along the first-chip plane,
is designed to apply a second DC voltage, and
is arranged on the first edge side with respect to the first-chip slot,
wherein the first chip comprises a first-chip high-frequency electrode, which is arranged opposite the first compensation electrode and a second compensation electrode on a second edge side opposite the first edge side with respect to the first-chip slot, and
is designed to apply a high-frequency voltage,
wherein the second chip comprises
a second-chip segment located downstream of the first-chip high-frequency electrode in a direction of a normal to the first-chip plane,
a second DC voltage electrode which
is arranged on the second-chip front side,
extends at least in sections along a second-chip plane along which the second chip extends, and
is designed to apply a third DC voltage, and
a second compensation electrode which
is arranged on the second-chip reverse side,
extends at least in sections along the second-chip plane, and
is designed to apply a fourth DC voltage,
wherein the second chip comprises a second-chip high-frequency electrode located downstream of the first-chip segment in the direction of the normal to the first-chip plane, and
wherein the first compensation electrode and the second compensation electrode are electrically insulated against each other.

2. The ion trap according to claim 1,
wherein the first-chip segment has a recess on an edge surface that is adjacent to the first-chip slot and extends transversely to the first-chip plane, and
wherein the first compensation electrode has a first-electrode recess section that extends along the first-chip plane and is spaced apart from the first-chip reverse side and the first-chip front side.

3. The ion trap according to claim 1 wherein the first DC voltage electrode extends along the first-chip plane in a recess section and is spaced apart from the first-chip reverse side; and
further comprising an insulating strip between the first-electrode recess section and the recess section.

4. The ion trap according to claim 1, wherein
(a) the first-chip segment is tongue-shaped and extends in a segment extension direction that extends transversely to a slot extension direction along which the first-chip slot (14) extends, and/or
(b) the second-chip segment is tongue-shaped and extends in a segment extension direction that extends transversely to a slot extension direction along which the second-chip slot extends.

5. The ion trap according to claim 3, wherein o a distance between the recess section and the first-chip reverse side is smaller than 0.7 times a substrate thickness of the first chip.

6. The ion trap according to claim 2 wherein the recess is designed such that the first compensation electrode is covered by the first DC voltage electrode as viewed from a trap volume of the ion trap.

7. The ion trap according to claim 6, wherein the sine of half the opening angle of a cone comprising a tip that lies in the center of the trap volume and which does not intersect the ion trap is at least 0.45.

8. The ion trap according to claim 1 wherein
a clear chip distance of the first chip and the second chip from each other deviates by at most 15% from a first slot width of the first-chip slot and/or from a second slot width of the second-chip slot.

9. The ion trap according to claim 1 wherein
the first chip comprises at least a second first-chip segment (configured next to the first-chip segment with respect to the slot extension direction, wherein the second first-chip segment is constructed in the same way as the first-chip segment.

10. The ion trap according to claim 1 wherein
(a) the first chip comprises at least three first-chip segments (that are arranged next to each other along the first-chip slot, and/or
(b) the second chip comprises at least three second-chip segments (that are arranged next to each other along the second-chip slot.

11. An ion trap system, comprising:
(a) an ion trap according to claim 1; and
(b) a control unit which
(i) is electrically connected to the first DC voltage electrode, the first compensation electrode, the first-chip high-frequency electrode, the second DC voltage electrode, the second compensation electrode, and the second-chip high-frequency electrode of the ion trap, and
(ii) is configured to automatically apply a high-frequency voltage to the first-chip high-frequency electrode and the second-chip high-frequency electrod, thereby forming the trap volume, and
a predetermined DC voltage on
each of the first compensation electrode and the second compensation electrode, and/or
each of the first DC voltage electrode and the second DC voltage electrode.

12. The ion trap system according to claim 11, further comprising a photodetector arranged to detect photons emitted by an ion arranged in the trap volume.
